(19) United States
(12) Patent Application Publication
(10) Pub. No.: US 2011/0274134 A1
(43) Pub. Date: Nov. 10, 2011

(54) SOLAR PUMPED LASER MICROTHRUSTER

(76) Inventors: Alexander Rubenchik, Livermore, CA (US); Raymond J. Beach, Livermore, CA (US); Jay W. Dawson, Livermore, CA (US); Craig W. Siders, Livermore, CA (US)

(21) Appl. No.: 13/084,686

(22) Filed: Apr. 12, 2011

Related U.S. Application Data
(63) Continuation-in-part of application No. 12/773,036, filed on May 4, 2010.

(51) Int. Cl. H01S 3/091

(52) U.S. Cl. 372/79

(57) ABSTRACT

A micro-thruster for controlling the positioning of a satellite includes a solar concentrator for collecting solar energy and producing concentrated solar energy. A solar panel is positioned to receive the concentrated solar energy and thereby produces electrical energy which in turn energizes a diode-pumped fiber optic laser. The energized laser thus produces laser light which is transmitted to ejector material affixed to a satellite.

### CROSS-REFERENCE TO RELATED APPLICATIONS

This application claims the benefit of U.S. Patent Application No. 61/175,333 titled “A Compact and Eco-Friendly System For Solar Power Beaming From Space To Earth,” filed May 4, 2009, incorporated herein by reference.

This application is a continuation-in-part of, and claims priority to, U.S. patent application Ser. No. 12/773,036 titled “Systems for Solar Power Beaming from Space,” filed May 4, 2010, incorporated herein by reference.

### STATEMENT REGARDING FEDERALLY SPONSORED RESEARCH OR DEVELOPMENT

The United States Government has rights in this invention pursuant to Contract No. DE-AC52-07NA27344 between the U.S. Department of Energy and Lawrence Livermore National Security, LLC, for the operation of Lawrence Livermore National Laboratory.

### BACKGROUND OF THE INVENTION

1. Field of the Invention

The present invention relates to the use of solar energy, laser and satellite technology, and more specifically, it relates to the use of solar energy to provide directional control of a satellite.

2. Description of Related Art

It is desirable to have a means for changing the orbit or orientation of a satellite. This has been done with the help of onboard engines that are used to produce the thrust. The weight of the engine and the weight of the required fuel are detrimental factors. Commonly used systems utilize ion propulsion where ionized atoms are accelerated by an electromagnetic field to generate thrust. Problems presented by these systems include the high power consumption required to ionize accelerating atoms, the need to compensate the spacecraft charge and the system complexity. Due to the incoherence of solar light, it is impossible to use it directly and to to get high-energy concentration and efficient propulsion.

Conventional motors take a lot of weight and require fuel with substantial additional weight. It is very attractive to find more suitable alternatives especially for light microsatellites. Recently [1] it was suggested to use a laser situated on the satellite to ablate some material and to produce the thrust. Specifically, it was suggested that a diode laser be used to ablate the material. However, the light from diode lasers is difficult to focus sufficiently to get the amount of high intensity that is required for ablation. Increasing the spot size increases the energy requirements and weight. Further, diode lasers are inefficient in the pulsed regime.

It is therefore desirable to provide a viable means for concentrating solar energy on a target to evaporate the target material and thereby create thrust.

### SUMMARY OF THE INVENTION

It is an object of the present invention to control the position of a satellite by providing means for collecting and concentrating solar energy that drives a fiber-optic laser which is configured to ablated ejector material affixed to the satellite.

This and other objects will be apparent based on the disclosure herein.

The development of microsatellites requires the development of engines to modify their orbit or orientation. The present invention provides embodiments that use solar energy to drive such engines. For an unlimited energy source, the optimal thruster must use a minimal amount of expendable material minimize weight and therefore minimize launch costs. This requires the ejected material to have the maximal velocity and hence, the ejected atoms must be as light as possible and be ejected by as high an energy density source as possible. As described herein, such propulsion can be induced by pulses from a short pulse laser. The short laser provides the required high-energy concentration and high-ejection velocity. Elements of the present microthruster system include an inflatable solar concentrator, a solar panel and a diode-pumped fiber laser. Fiber optics transmit laser power to ejector material attached to the satellite.

### BRIEF DESCRIPTION OF THE DRAWINGS

The accompanying drawing, which is incorporated into and forms a part of the disclosure, illustrates an embodiment of the invention and, together with the description, serves to explain the principles of the invention.

FIG. 1 shows and embodiment of the present solar powered, laser based propulsion system.

### DETAILED DESCRIPTION OF THE INVENTION

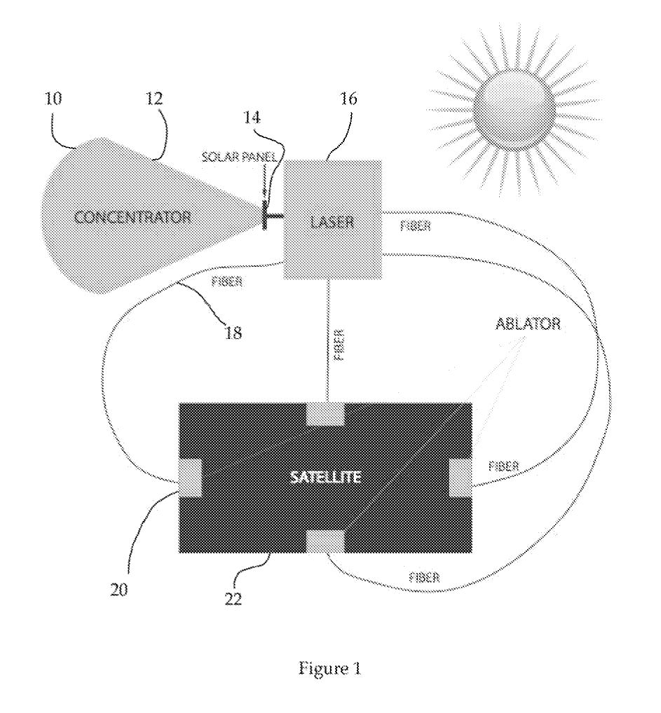

The present microthruster system utilizes a diode pumped fiber laser for the ablation driver. This scheme provides efficiency, flexibility and is lightweight. The laser power supply can be produced from a solar panel located on the satellite of interest, or the power supply can be a separate, lightweight solar system. The scheme of an embodiment of the present propulsion system is presented on FIG. 1.

In order to move the satellite in all possible directions one must have, generally, six independent motors to thrust the satellite in x, y, z directions, to provide movement forward and back. Additional motors can be required to change the satellite orientation. In a present laser scheme, this is achieved with one laser with energy delivered via fibers to different locations on the satellite where the ablation material will be located. Solar energy is used to pump the laser. As shown in the figure, a lightweight and inexpensive inflatable mirror 10 concentrates the solar radiation 12 on a multi-junction solar panel 14 with efficiency of, e.g., over 40% [2]. The produced electricity produced by the solar panel is used to pump the fiber laser 16. Light from fiber laser 16 is transported by fiber optics 18 to the thrusters 20 located on satellite 22. For average operational power of ˜1 watt, the required concentrator size is ˜15 cm and the solar panel is ˜1 cm. The total weight of the system can be few hundred grams. When the laser is idle, the solar panel energy can be used for satellite needs. Alternately, the existing power system of the satellite can be used to pump the laser.

Consider first the requirements for the laser system and ablators. Usually, the propulsion efficiency is described in terms of momentum coupling Cₘ, which is the ratio of acquired momentum to incident laser efficiency [3]. The maximum of Cₘ corresponds to the maximum momentum produced for the fixed laser energy. For the present invention, the energy is not limited, the limiting quantity is the amount of ablatable material. For the best use, the material must be ejected with the maximal possible velocity. In such case, the system must operate in a regime of the highest specific momentum [1]. It is desirable to have high energy density in each laser pulse, which is best achieved in the short pulse regime. The ablator must be as light as possible. Lithium hydrate (LiH) is used in some embodiments. The ablator can be placed in a refractory metal pipe to increase the directionality of ejected material and the propulsion efficiency. Also, the material of the satellite not necessary for the satellite operation can be used for the ablation and propulsion. Below we present a design for the laser based on modern technology.

The optimal laser can be a diode-pumped short-pulse fiber-laser with high conversion efficiency (˜5%) of electricity in laser radiation (˜50% electrical-optical in the diode laser and ˜10% optical to optical conversion efficiency in the fiber laser as it would operate at low repetition rate (<2 kHz) and high pulse energy yielding 10%×50%=5% overall electrical to optical efficiency). This efficiency would increase with increasing repetition rate yielding up to 40% electrical to optical efficiency at >100 kHz repetition rate. The distance from the laser to the target is short and one can afford to use multimode pulses from large area fibers. In this case, the pulse energy is not limited by self-focusing to 4 MW peak powers as in conventional single mode fibers. Instead, the pulse energy is limited only by damage to ˜40 J/cm² for 1 ns pulses. Thus, a 200 μm core fiber could have an output energy per pulse as high as ˜10 mJ. The typical optimal pulse duration will be in the nanosecond range. The laser would consist of a simple master-oscillator power amplifier design. A nominal design might start with a small Q-switched solid-state micro laser producing 10-50 μJ pulses that would be focused into a 200 gm core multimode Yb doped optical fiber with a target gain of 1000×. This fiber would be pumped by a 200 W to 2 kW diode laser array coupled to the cladding by a simple lens duct. The final power of the diode array would be determined by the desired repetition rate of the laser with higher repetition rate lasers being desired from an efficiency standpoint. For 200 W of pump power, a 1-2 kHz, 10 mJ/pulse device with 5% conversion efficiency could be constructed. For 2 kW of pump power, a 10-20 kHz, 10 mJ/pulse device with 25% conversion efficiency could be constructed. The fiber cladding is constructed to be large enough to be compatible with the diode laser array brightness and the length would be required to be short enough to ensure other non-linear effects such as stimulated Raman scattering do not degrade the output pulses. The combination of length and cladding size may result in a design trade-off, although recent breakthroughs in fibers with high Yb doping concentrations has begun to mitigate this issue significantly. The conventional laser design can be stripped down for present applications. Because the time to change the orbit is not limited, the laser can operates in heat capacity mode, without external cooling. Such a laser might operate at power for up to 5 seconds prior to being turned off for cooling. The small thrust produced by the single pulse will provide the high accuracy of satellite movements. In this time using the scheme described above, 100-1000J of total laser energy could be delivered to the lithium hydrate target in the short pulse form required to achieve the desired thrust. The laser elements must be thermally connected with main satellite for the general radiation cooling. Total system weight can be within 5 pounds.

Let us estimate the thrust produced by such a propulsion system. The optimal fluence F for maximum coupling Cₘ of ˜5 dyn sec/J is given by [3]

F=2.5\sqrt{τ(n sec)}J/cm² (1)

The numerical coefficient in (1) is related to interaction with A1, but it is not sensitive to material. For a 10 mJ pulse with a 1 ns pulse duration the optimal fluence is achieved with a laser spot diameter of 700 μm. The momentum produced by one pulse with above coupling coefficient M˜0.05 dyn sec. For one hundred joules train it will be M ˜500 dyn sec. For a 5 sec pulse train it will produce a thrust of ˜1 mN.

The paper [1] indicates the desirable parameters of propulsion system-thrust per axis to be >100 μN, weight per axis to be ˜1 kg and specific impulse to be ˜500 sec. Because embodiments of the present invention utilize one laser for all axes, both weight and thrust requirements are satisfied. The ejected velocity (specific impulse) will therefore be very high. It can be even higher for tighter focusing and lower coupling efficiency.

References (Incorporated Herein by Reference):

C. Phipps, J. Luke Diode laser-driven microthruster: a new departure for Micropropulsion. AIAA Journal 40, 310, 2002

Photonics Spectra December 2008 pp.40

C. Phipps et al. J. Appl Phys. 64.1083.1988.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

We claim:

1. An apparatus, comprising:
a solar concentrator for collecting solar energy and producing concentrated solar energy;
a solar panel positioned to receive said concentrated solar energy, wherein said solar panel produces electrical energy;
a laser electrically connected to receive said electrical energy from said solar panel, wherein said laser produces laser light;
means for transmitting at least a portion of said laser light to ejector material affixed to a satellite.

2. The apparatus of claim 1, wherein said solar concentrator comprises an inflatable solar concentrator.

3. The apparatus of claim 1, wherein said laser comprises a diode-pumped fiber laser.

4. The apparatus of claim 3, wherein said laser is configured to provide pulses having a short pulse length.

5. The apparatus of claim 1, wherein said means comprise a plurality of fiber optics.

6. The apparatus of claim 1, wherein said ejector material comprises lithium hydrate.

7. The apparatus of claim 1, wherein said laser is configured to provide laser pulses having a repetition rate within a range from about 2 kHz to about 100 kHz.

8. The apparatus of claim 1, wherein said laser is configured to provide laser pulses having a repetition rate of greater than 100 kHz.

9. The apparatus of claim 5, wherein at least one fiber optic of said plurality comprises a large area fiber.

10. The apparatus of claim 9, wherein said laser light is multimode.

11. The apparatus of claim 4, wherein said pulses comprises a duration within the nanosecond range.

12. The apparatus of claim 1, wherein said laser comprises no active cooling system.

13. The apparatus of claim 12, wherein said laser is thermally connected with said satellite for general radiation cooling.

14. The apparatus of claim 1, further comprising said satellite.

15. The apparatus of claim 1, wherein said solar panel is part of said satellite.

16. A method, comprising:
with a solar concentrator, collecting solar energy and producing concentrated solar energy;
directing said concentrated solar energy onto a solar panel, wherein said solar panel produces electrical energy;
energizing a laser with said electrical energy, wherein said laser produces laser light; and
transmitting at least a portion of said laser light to ejector material affixed to a satellite.

17. The method of claim 16, wherein said solar concentrator comprises an inflatable solar concentrator.

18. The method of claim 16, wherein said laser comprises a diode-pumped fiber laser.

19. The method of claim 18, wherein said laser is configured to provide pulses having a short pulse length.

20. The method of claim 16, wherein said means comprise a plurality of fiber optics.

21. The method of claim 16, wherein said ejector material comprises lithium hydrate.

22. The method of claim 16, wherein said laser is configured to provide laser pulses having a repetition rate within a range from about 2 kHz to about 100 kHz.

23. The method of claim 16, wherein said laser is configured to provide laser pulses having a repetition rate of greater than 100 kHz.

24. The method of claim 20, wherein at least one fiber optic of said plurality comprises a large area fiber.

25. The method of claim 24, wherein said laser light is multimode.

26. The method of claim 19, wherein said pulses comprises a duration within the nanosecond range.

27. The method of claim 16, wherein said laser comprises no active cooling system.

28. The method of claim 27, wherein said laser is thermally connected with said satellite for general radiation cooling.

29. The method of claim 16, further comprising said satellite.

30. The method of claim 16, wherein said ejector material is part of said satellite.
